(19) United States
(12) Patent Application Publication
(10) Pub. No.: US 2012/0327645 A1
(43) Pub. Date: Dec. 27, 2012

(54) FLOOD LAMP WITH IMPROVED ANGULAR LIGHTING UNIFORMITY

(75) Inventors: Yuanpeng Benjamin You, Hsinchu City (TW); Geoffrey Wen-Tai Shuy, Hong Kong (CN); Hsin-Chen Lai, Taichung City (TW); Jonathan Li, Hsinchu City (TW)

(73) Assignee: ARMI Products Corporation, HsinChu (TW)

(21) Appl. No.: 13/169,297

(22) Filed: Jun. 27, 2011

(51) Int. Cl. F21L 13/00; F21V 7/00

(52) U.S. Cl. 362/192; 362/235

(57) ABSTRACT

In an aspect, in general, a lighting fixture includes a plurality of light sources, each light source including an array of light emitting diodes and a reflective surface. The reflective surface of each of the light sources is configured to reflect at least a portion of near field light produced by the other light sources into the far field.

### BACKGROUND

This invention relates to a flood lamp with improved angular lighting uniformity.

An ideal flood lamp projects all lighting output uniformly into an intended illumination area. Any light that is projected outside of the intended illumination area is considered to be a waste of energy. Consequently, many conventional flood lamp fixtures include reflectors, which re-direct any stray lighting into the intended illumination area. The inclusion of additional reflectors can increase the cost, volume, and weight of the flood lamp.

One typical application of flood lamps is in conventional diesel power generator based lighting equipment for large outdoor working areas (e.g., 50 meters wide and 100 meters long). Such lighting equipment can include multiple (e.g. up to six) units of metal halide (MH) flood lamps, each consuming up to 1500 W of power. Typically, each of these metal halide flood lamps has a full-width-half-maximum (FWHM) angular spread of 15° to 30°. FWHM is a characterization of angular luminance uniformity which is used when angular luminous intensity can be approximated by a normal distribution function.

Referring to FIG. 1, an exemplary lighting distribution of a metal halide flood lamp shows that the angular spread of the distribution is narrow, resulting in the illumination produced by the flood lamp being focused over a relatively narrow portion of the intended illumination area. When illuminating a large area to a specified minimum brightness, the intensity of illumination in the narrow portion can reach harmful levels (e.g., greater than 1000 lux). In some instances, workers must wear sunglasses in order to prevent damaging their vision. Furthermore, a steep gradient in brightness can cause dizziness for quickly moving workers.

### SUMMARY

In an aspect, in general, a lighting fixture includes a plurality of light sources, each light source including an array of light emitting diodes and a reflective surface. The reflective surface of each of the light sources is configured to reflect at least a portion of near field light produced by the other light sources into the far field.

Aspects may include one or more of the following features.

The reflective surface of each of the plurality of light sources may be planar. The lighting fixture can include an opening through which light produced by the plurality of light sources projects. The array of light emitting diodes can have dimensions of at least 2×2 light emitting diodes. The angular luminous intensity of each light source of the plurality of light sources can be characterized as a full-width-half-maximum angle, θ, and the far field lighting distribution produced by the lighting fixture can have a full-width-half-maximum angle that is greater than 2θ. θ can be less than 45°.

In another aspect, in general, a lighting tower includes a power generation apparatus for providing power to a plurality of lighting fixtures which are in electrical connection with the power generation apparatus; and a support structure configured to support the plurality of lighting fixtures at a desired elevation. The lighting fixture includes, a plurality of light sources, each light source including an array of light emitting diodes and a reflective surface. The reflective surface of each of the light sources is configured to reflect at least a portion of near field light produced by the other light sources into the far field.

Aspects may include one or more of the following features.

The reflective surface of each of the plurality of light sources may be planar. The lighting fixture may include an opening through which light produced by the plurality of light sources projects. The array of light emitting diodes can have dimensions of at least 2×2 light emitting diodes. The angular luminous intensity of each light source of the plurality of light sources can be characterized as a full-width-half-maximum angle, θ, and the far field lighting distribution produced by the lighting fixture can have a full-width-half-maximum angle that is greater than 2θ. θ can be less than 45°.

Embodiments may include one or more of the following advantages:

Among other advantages, a flood lamp is designed to include at least two coplanar LED light sources, yielding improved angular lighting uniformity than can be achieved using a single LED light source. Specifically, the narrow far-field angular lighting distributions of the LED light sources light engines are combined with reflected near-field lighting, resulting in an LED flood lamp with improved far-field lighting uniformity.

In particular, far field lighting uniformity is improved by combining a proper lamp fixture designed to redistribute the light intensity and a proper reflection surface arrangement to convert near field illumination into wide-angle uniform far field illumination. When the resulting far field lighting distribution is approximated by a normal distribution function, the flood lamp's FWHM can easily exceed 100° when using LED light engines with FWHM less than 45°.

The flood lamp converts part of the near field illumination into far field illumination using existing reflection surfaces of at least two mass-produced LED light engines. The far field luminous intensity distribution of flood lamp includes multiple local maxima interlaced with local minima. When approximated by a normal distribution function, the far field lighting distribution has a characteristic full-width-half-maximum (FWHM) angular spread that is greater than twice the characteristic FWHM of any single LED light engine.

The flood lamp requires less power than conventional flood lamps to produce the same brightness, thus saving energy.

The flood lamp produces less heat and no UV radiation, thus making it safer than conventional flood lamps. Furthermore, due to the reduced danger of heat and UV radiation, the flood lamp can be located closer to the ground than conventional flood lamps (e.g., 5 to 7 meters instead of >9 meters required by conventional flood lamps), thus saving on material and engineering costs of the lamp boom.

The increased angular lighting uniformity provided by the flood lamp provides a larger comfortable working zone (e.g., between 20 and 500 lux illumination) than conventional flood lamps which can include areas of dangerously high luminous intensity (e.g., 1000 lux).

One or more approaches described herein provide advantages over previously published approaches as follows:

Patent searches revealed four patents that use multiple LED light sources with ability to adjust the projecting light from a spot lighting to a wide spread flood lighting and vice versa. They can be grouped into two categories: (1) a partial parabolic lamp with adjustable focal length via mechanically relocating its lighting elements, and (2) a lamp with alterable refraction means to adjust its focal length. Also, one patent describes a lamp with multiple LED elements fixed at different locations with different angles that can focus its illumination onto the object to be shined intensively. They are analyzed in the following:

U.S. Pat. No. 6,585,395 (Luk): Variable Beam Light Emitting Diode System, U.S. Pat. No. 6,908,214 (Luk): Variable Beam LED Light Source System: These patents describe the use of multiple LED light sources as part of parabolic surface to project their light. This apparatus can mechanically change the relative locations of their light elements to become a partial parabolic lamp with several (at least two) inter-changeable focal lengths, thus it can adjust the projecting light from a spot lighting to a wide spread flood lighting and vies versa without any additional reflector or lens.

U.S. Pat. Pub. 2008/0192473 A1 (Noirot): Floodlight with Variable Beam, U.S. Pat. Pub. 2009/0296408 A1 (Hendriks): Light Distribution: These patent publications describe two different adjustable lens combination groups that can change the light projection of a LED lamp from a spot lighting into flood lighting and vice versa.

U.S. Pat. No. 6,626,558 (Momot): Apparatus for Illumination of an Object: This patent describes a lamp with multiple LED elements fixed at different locations with different angles that can focus the light onto an illuminated object with high intensity.

The approaches described herein make use the existing (or additional if a more proficient design required) reflection surfaces of at least two coplanar LED light engines to design lamps such that it can convert the wasteful portion of the near field lighting to improve the uniformity of the far field lighting. Thus the approaches described herein do not overlap with the subject matter of the prior art.

Other features and advantages of the invention are apparent from the following description, and from the claims.

### DESCRIPTION OF DRAWINGS

FIG. 1 is a linear light distribution curve of a metal halide flood lamp.

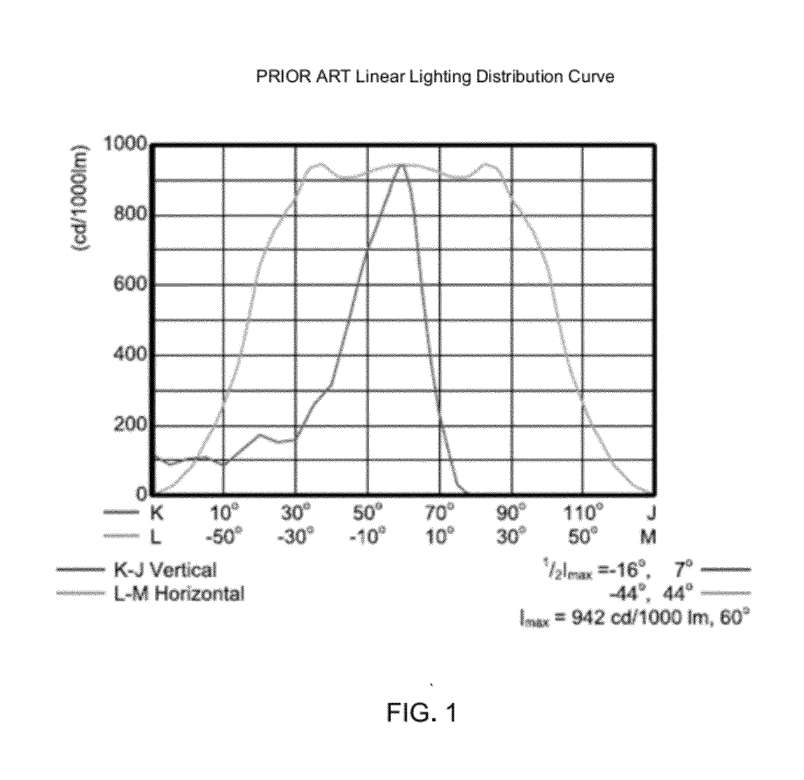

FIG. 2 is a lighting tower including LED flood lamps.

FIG. 3 is a single LED light engine.

FIG. 4 is a linear light distribution curve of a single LED light engine.

FIG. 5 shows a number of views of a single LED flood lamp.

FIG. 6 is a linear light distribution curve of a LED flood lamp.

### DESCRIPTION

### 1 Overview

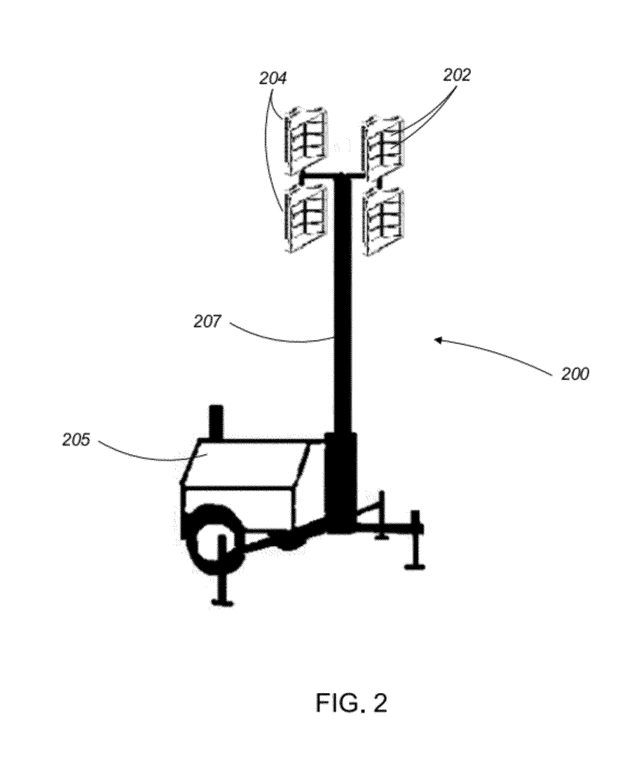

Referring to FIG. 2, a lighting tower 200 includes a power generation apparatus 205 (e.g., a diesel power generator), a lighting fixture support structure 207 (e.g., a boom or mast), and four LED flood lamps 204 configured such that a work area is uniformly illuminated.

In general, the power generation apparatus 205 generates electrical power which is supplied to each of the flood lamps 204 which are supported at a desired elevation by the lighting fixture support structure 207. Each flood lamp 204 includes a number of off-the-shelf LED light engines 202 which are configured to uniformly distribute light over a work area. The flood lamp 204 achieves the uniform distribution by utilizing pre-existing planar reflective surfaces of the individual LED light engines 202 to redirect near-field illumination into the far field.

In some examples, the flood lamps 204 are used to replace conventional metal halide lamps in lighting towers in a retrofit manner. For example, each metal halide flood lamp which is used in a conventional lighting tower can be cost-effectively replaced by an LED flood lamp 204.

### 2 LED Light Engines

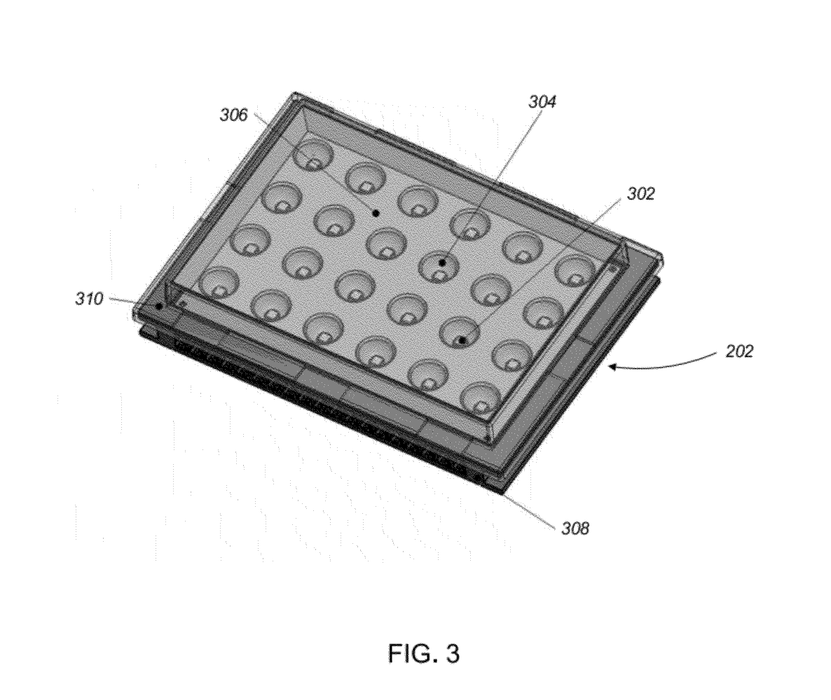

Referring to FIG. 3, one example of a single LED light engine 202 includes an array of coplanar LED elements 302 disposed in indented semi-spherical reflecting cups 304 and arrayed in a planar surface 306. In this example, the coplanar LED elements 302 are arranged in a rectangular matrix. The reflecting cups 304 serve to project the lighting produced by the LED light element 302 outwardly and perpendicular to the planar surface 306. Furthermore, the cups 304 are collectively indented in a polished metal plate such that cups 304 and connecting planar surface 306 are good reflection surfaces which are built from the same material and finish. The exemplary LED light engine 202 shown in FIG. 3 is a 4 by 6 matrix of LED elements 302, however different matrix sizes are possible (e.g., 2×2, 2×3, 2×4, . . . 4×6, etc.).

An LED light engine 202 such as the light engine shown in FIG. 3 typically includes a power module and circuit connections to provide the proper electric power to the distributed LED element matrix, LED elements 302 to covert electric power to light effectively, a heat dissipating module 308 to maintain a low junction temperature (say, <65° C.) for every LED element 302 during operation, a reflecting structure 304 for shaping the light distribution for specific applications, a support structure, and a mechanism 310 to provide protection against dust and water (e.g., IP65, IP67 or IP68).

Furthermore, LED light engines 202 are designed conform to size, shape, and weight specifications, as well as efficacy, durability, reliability, and ruggedness requirements. The light engines are also designed to be affordable and environmentally friendly.

Due to their robust design, low cost, and low power consumption, LED light engines 202 are ideal for use in flood lamps such as those used in lighting tower applications. However, one limitation of the LED light engines is that their far field angular intensity distribution typically has a full-width-half-maximum (FWHM) of less than 100° which is too small for such applications.

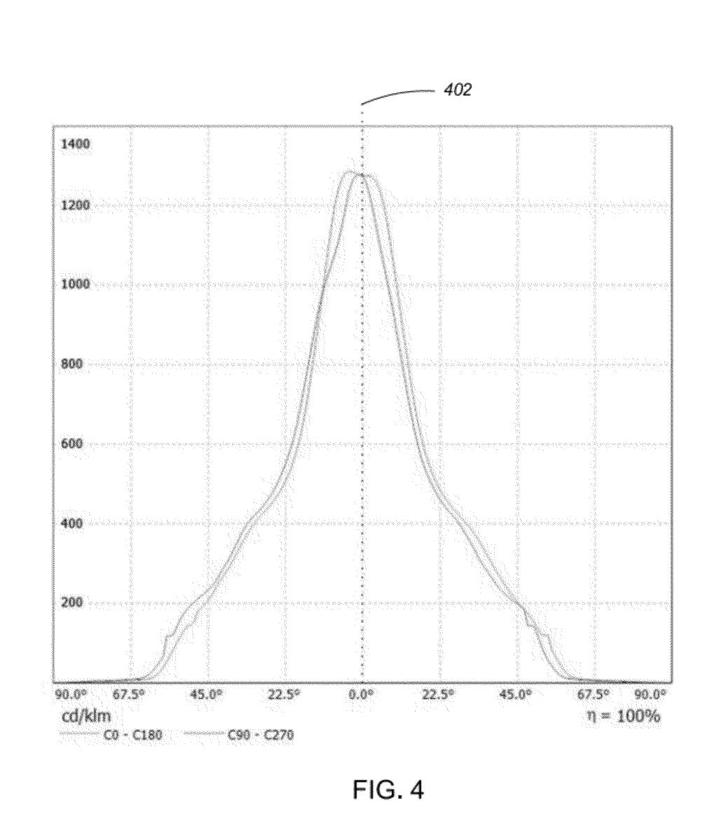

For example, referring to FIG. 4, a graph of a linear light distribution curve (LDC) of a single LED light engine 202 mounted at 6 meters is shown. The LDC curve is substantially shaped as a normal distribution with a FWHM angle, θ, less than 45° of its far field luminous intensity. The FWHM angle, θ, is limited by the design of the reflective cups 304. The maximum luminous intensity is located at a line 402 protruding through the geometric center of the light element matrix and perpendicular to the surface of the light engine. Line 402 is commonly referred to as the “maximum intensity line.”

One way to improve the FWHM of a LED light engine 202 is to completely redesign a LED light engine 202 to the desired specifications. However, designing and building a light engine with a FWHM greater than 100° would involve costly reengineering, new tooling and a new process development effort.

### 3 LED Flood Lamp

While it is impractical and costly to completely redesign an LED light engine 202, it is more practical and cost effective to design a flood lamp fixture which optimally uses off-the-shelf LED light engines 202. The optimal flood lamp design takes advantage of the fact that every light engine 202 projects its light into its near field as well as its far field. Furthermore, some of the near field illumination produced by LED light engines 202 never reaches the far field lighting area when mounted in a conventional lamp fixture. In some conventional LED flood lamps, only ⅔ to ¾ of light energy produced by LED light engines 202 projects into the intended far-field area when all the maximum intensity lines of the LED light engines 202 are aligned in one direction, or when using lamp fixture design to redistribute the intensity without the following reflection. The LED flood lamp described herein converts a portion of the near field illumination of neighboring light engines 202 into useful far field illumination by optimally utilizing the reflective surfaces 306 of the LED light engines 202 included in the flood lamp.

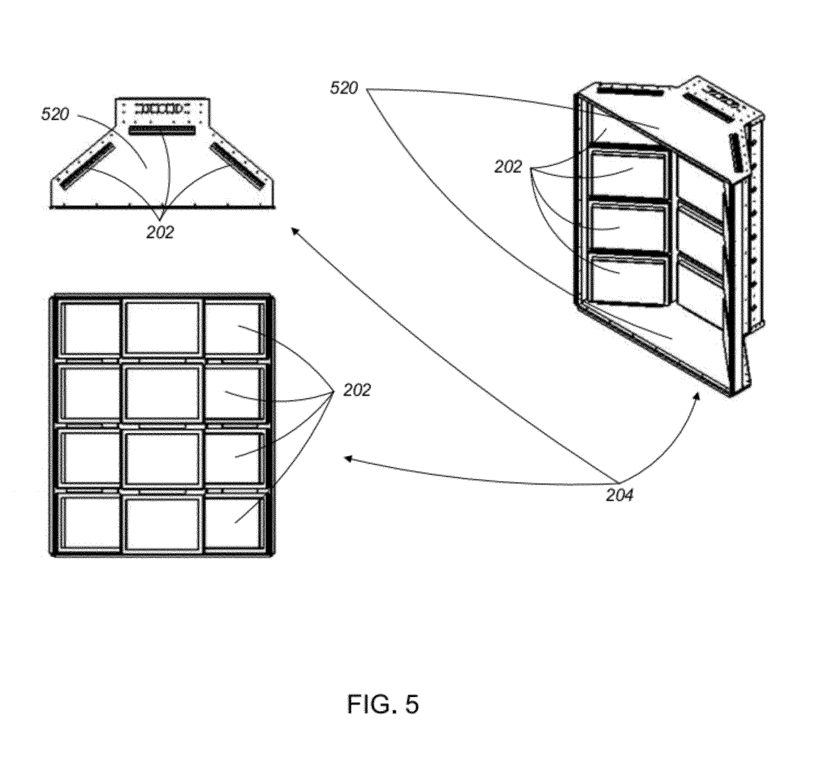

Referring to FIG. 5, an LED flood lamp 204 is designed to project a substantially uniform far field lighting intensity inside an intended lighting area. The flood lamp 204 includes twelve LED light engines 202 in a three column formation and configured to achieve a uniform distribution. In other examples, the number of LED light engines 202 can be any number greater than or equal to two.

The LED light engines 202 are fixtured such that they distribute far field lighting intensity as uniformly as possible over the intended lighting area. The LED light engines 202 are also angled such that the flood lamp 204 takes advantage of the existing reflecting structure 306 in nearby light engines 202 to redirect part of the typically wasted near field illumination into useful far field illumination. At the top and bottom of the columns, end-plates 520 are utilized as additional reflection surfaces that reflect near field illumination that might otherwise escape. This configuration improves the far field uniformity of the flood lamp 204 without the added cost of additional reflecting surfaces.

### 4 Results

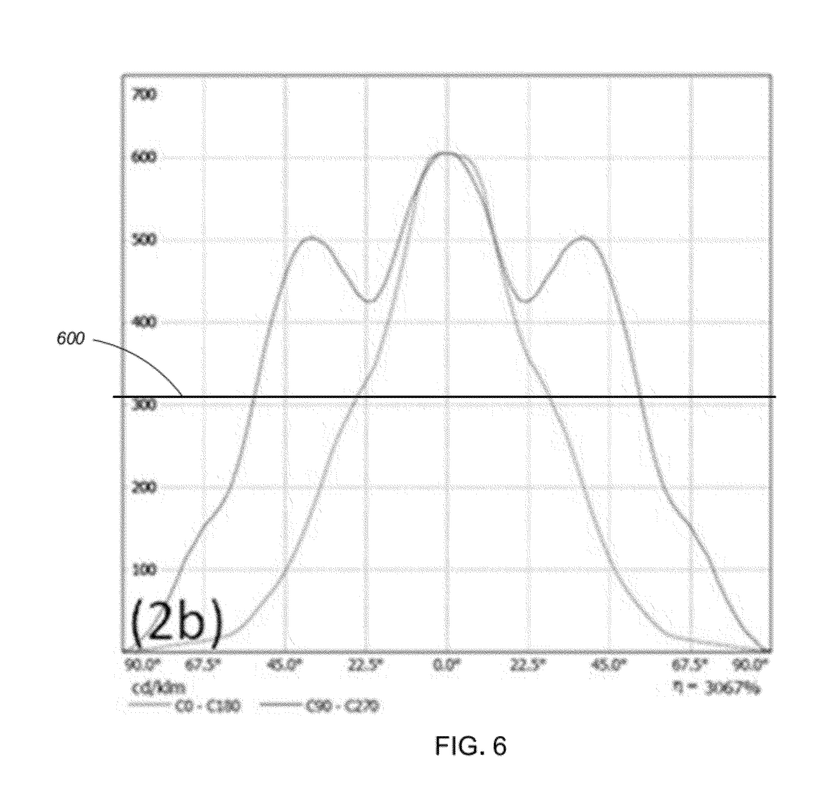

Referring to FIG. 6, a graph of the linear LDC of the flood lamp 204 of FIG. 5 mounted at 6 meters is shown. The flood lamp has FWHM angle, θ, greater than 100° (i.e., the angular spread at the horizontal line 600). The graph illustrates that the far field distribution of illumination provided by the flood lamp 204 is substantially uniform and does not include an area of hazardously high illumination (i.e., the luminous intensity peaks at 600 lux).

As can be seen in FIG. 6, the far field lighting distribution is not exactly a uniform distribution. However, the distribution is substantially constant across a wide angle in front the common opening window. The distribution is formed by multiple local maxima which are interlaced with local minima. The local minima can be much greater than half of the local maximum luminous intensity. The luminous intensity fades away slowly from the outmost local maxima at each side of the normal line which defined by the lamp window. The angle between these two outmost local maxima is much greater than the angle that characterizes the FWHM of any single mounted LED light engine 202 included in the flood lamp 204.

The power consumed by a lighting tower utilizing the LED flood lamps 204 is significantly less than the power consumed by a comparable lighting tower utilizing metal halide flood lamps. For example, in a typical application of a lighting tower, at least four LED flood lamps 204 are required to illuminate a lighting area. Each of the LED flood lamps 204 includes approximately 12 40 W LED light engines, thereby consuming approximately 480 W. It follows that each lighting tower using the LED flood lamps 204 consumes less than 2000 W. In contrast, an equivalent metal halide lighting tower consumes 6000 W (i.e., 3 times the power).

### 5 Alternatives

While the preceding description applies to using an LED flood lamp 204 in lighting towers, the LED flood lamp 204 can be used in many other applications. For example, the flood lamp could be mounted on buildings or other tall structures to illuminate a large area (e.g. an airport runway, a naval yard, etc.).

In some examples, the reflective surfaces 306 of the LED light engines 202 can be used in conjunction with additional reflective structures which are placed with a with position and angle of placement capable of re-directing the stray near-field lighting into the intended far-field area.

It is to be understood that the foregoing description is intended to illustrate and not to limit the scope of the invention, which is defined by the scope of the appended claims. Other embodiments are within the scope of the following claims.

What is claimed is:

1. A lighting fixture comprising:
a plurality of light sources, each light source including an array of light emitting diodes and a reflective surface,
the reflective surface of each of the light sources being configured to reflect at least a portion of near field light produced by the other light sources into the far field.

2. The lighting fixture of claim 1 wherein the reflective surface of each of the plurality of light sources is planar.

3. The lighting fixture of claim 1 further comprising an opening through which light produced by the plurality of light sources projects.

4. The lighting fixture of claim 1, wherein the array of light emitting diodes has dimensions of at least 2×2 light emitting diodes.

5. The lighting fixture of claim 1 wherein the angular luminous intensity of each light source of the plurality of light sources is characterized as a full-width-half-maximum angle, θ, and the far field lighting distribution produced by the lighting fixture has a full-width-half-maximum angle that is greater than 2θ.

6. The lighting fixture of claim 5 wherein θ is less than 45°.

7. A lighting tower comprising:
a power generation apparatus for providing power to a plurality of lighting fixtures which are in electrical connection with the power generation apparatus; and
a support structure configured to support the plurality of lighting fixtures at a desired elevation;
wherein the lighting fixture includes,
a plurality of light sources, each light source including an array of light emitting diodes and a reflective surface,
the reflective surface of each of the light sources being configured to reflect at least a portion of near field light produced by the other light sources into the far field.

8. The lighting tower of claim 7 wherein the reflective surface of each of the plurality of light sources is planar.

9. The lighting tower of claim 7 wherein the lighting fixture further includes an opening through which light produced by the plurality of light sources projects.

10. The lighting tower of claim 7, wherein the array of light emitting diodes has dimensions of at least 2×2 light emitting diodes.

11. The lighting tower of claim 7 wherein the angular luminous intensity of each light source of the plurality of light sources is characterized as a full-width-half-maximum angle, θ, and the far field lighting distribution produced by the lighting fixture has a full-width-half-maximum angle that is greater than 2θ.

12. The lighting tower of claim 11 wherein θ is less than 45°.
